(19) United States
(12) Patent Application Publication
(10) Pub. No.: US 2009/0213749 A1
(43) Pub. Date: Aug. 27, 2009

(54) METHOD FOR DETECTING THE QUALITY OF A SERVICE PARAMETER AND NETWORK SIDE COMMUNICATION DEVICE

(75) Inventor: Lufeng HAN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/437,825

(22) Filed: May 8, 2009

Related U.S. Application Data
(63) Continuation of application No. PCT/CN2007/071342, filed on Dec. 27, 2007.

(30) Foreign Application Priority Data
May 15, 2007 (CN) 200710028016.3

(51) Int. Cl. H04J 1/16; H04W 4/00

(52) U.S. Cl. 370/252; 370/328

(57) ABSTRACT

A method for detecting a quality of service (QoS) parameter includes: a network side communication device compares a QoS parameter obtained by network negotiation with a minimum acceptable QoS (MINQoS) parameter required by terminal equipment (TE) after acquiring the QoS parameter obtained by network negotiation during a PDP context activation process. If the QoS parameter obtained by network negotiation does not satisfy the MINQoS parameter requirement, the current PDP context activation is rejected. The network side communication device is also provided. With the present invention, rejection for the PDP context activation is realized by the network side communication device, occupied network and equipment resources are rapidly released in an unsuccessful PDP context activation process, thereby enhancing system work efficiency and network reaction time.

### CROSS-REFERENCE TO RELATED APPLICATIONS

This application is a continuation of International Patent Application No. PCT/CN2007/071342, filed Dec. 27, 2007, which claims priority to Chinese Patent Application No. 200710028016.3, filed May 15, 2007, both of which are hereby incorporated by reference in their entirety.

### FIELD OF THE TECHNOLOGY

The present invention relates to a communication field, and more particularly to a method for detecting a quality of service (QoS) parameter and a network side communication device.

### BACKGROUND

Along with sharp increase of the number of mobile subscribers and an increasingly high requirement for data services, because a conventional second generation (2G) mobile communication system mainly provides voice services, although it can still provide the data services, lower service rate and limited QoS capability already cannot meet the requirements of future new mobile communication services, such as multimedia and electronic business. Therefore, a third generation (3G) mobile communication system is expected to combine various multimedia communications together, such as radio communication and Internet, so as to process multiple media information, such as image, music and video stream, thereby to provide various services, including webpage browsing, conference call and electronic business. In order to realize the above expectation, a universal mobile telecommunication system (UMTS) has been proposed recently.

The UMTS cellular communication technique is a new global system for mobile communication (GSM) data communication technique. A UMTS core network technique standard is developed on the basis of a GSM/general packet radio service (GPRS), which inherits the GSM in a better way. The UMTS adopts a structure similar to the GSM system. As shown in FIG. 1, the UMTS includes a radio access network (RAN) and a core network (CN). The RAN processes all the functions related to radio access, and the CN processes all the speech calls and data connections within the UMTS system and realizes switching and routing functions with an external network, for example, public land mobile-communication network (PLMN), public switched telecommunication network (PSTN), integrated services digital network (ISDN), Internet etc. The equipment functions included in network units RAN and CN are described as follows.

A user equipment (UE), also called a mobile station (MS), performs data interaction with network equipment through a Uu interface, so as to provide various services in a circuit switched domain and a packet switched domain for the subscribers.

A UMTS terrestrial radio access network (UTRAN) includes a base station (BS) and a radio network controller (RNC), in which the BS is mainly responsible for radio data transmission and participates in radio resource management, and the RNC mainly manages and controls the radio resources within the region responsible by the RNC.

A mobile switching centre/visitor location register (MSC/VLR) is a circuit switched domain function node in the CN, and mainly provides call control, mobility management, authentication, and encryption in the circuit switched domain.

A gateway mobile services switching center (GMSC) is a gateway node between the circuit switched domain and an external network, which is an optional function node and mainly serves as a mobile gateway exchange between a mobile network and a fixed network.

A serving GPRS support node (SGSN) is a packet switched domain function node in the CN and mainly provides routing forward, the mobility management, session management, the authentication and the encryption in the packet switched domain.

A gateway GPRS support node (GGSN) is the packet switched domain function node in the CN and mainly provides an interface function with an external Internet protocol (IP) packet switched network.

A home location register (HLR) is a function node shared by the circuit switched domain and the packet switched domain in the CN, and mainly provides functions of saving subscribed information, supporting new services and enhanced authentication for the subscribers.

In the UMTS system, a general flow for a packet data protocol (PDP) context activation is described as follows. A PDP context activation request message sent by the MS to the network carries the QoS parameter requested by the MS. If the PDP context activation is successfully finished, the network returns a PDP context activation successful message carrying the QoS parameter after network negotiation to the MS. After receiving the PDP context activation successful message, the MS detects whether the QoS parameter after the network negotiation satisfies a minimum acceptable QoS (MINQoS) requirement configured on the MS. If the QoS parameter after the network negotiation does not satisfy the MINQoS requirement configured on the MS, the MS triggers to deactivate the activated PDP context and an execution flow thereof may be shown as FIG. 2, which includes the following steps.

Block s201: The MS sends the PDP context activation request message to the SGSN. The PDP context activation request message carries the QoS parameter requested by the MS.

Block s202: The SGSN sends a PDP context creation request message to the GGSN.

Block s203: After establishing the PDP context, the GGSN returns a response message to the SGSN.

Block s204: After determining to establish a radio access bearer (RAB), the SGSN sends a RAB allocation request message to the UTRAN.

Block s205: An information interaction is performed between the UTRAN and the MS to establish the RAB.

Block s206: The UTRAN returns an RAB allocation response message to the SGSN.

Block s207: The SGSN sends a PDP context update request message to the GGSN.

Block s208: The GGSN returns a response message of the PDP context update request message to the SGSN.

Block s209: The SGSN sends the PDP context activation successful message to the MS. The PDP context activation successful message carries the QoS parameter allocated to the MS after the network negotiation.

Block s210: The MS compares the QoS parameter allocated to the MS after the network negotiation carried in the PDP context activation successful message with the MINQoS set on the MS.

Block s211: If it is compared by the MS that the QoS parameter allocated to the MS after the network negotiation does not satisfy the MINQoS requirement, the MS sends a PDP context deactivation request message to the SGSN.

Block s212: The SGSN processes the PDP context deactivation request message and sends an activated PDP context deletion request message to the GGSN.

Block s213: The GGSN sends the PDP context deactivation response message to the SGSN.

Block s214: The SGSN returns a PDP context deactivation successful message to the MS.

Block s215: The established RAB is released.

During the implementation process of the present invention, the inventor found that in the PDP context activation flow of the conventional art, the PDP context deactivation step is triggered if the QoS parameter obtained by the network negotiation is determined not to satisfy the MINQoS configured on the MS, so the network and equipment resources continuously occupied by the network side communication device during the PDP context activation flow do not achieve the corresponding expected functions but are released if the PDP context is deactivated so as to result in wastes of the communication resources.

### SUMMARY

The technical problem to be solved by the embodiments of present invention is to provide a method for detecting a QoS parameter and a network side communication device.

In order to solve the above technical problem, the embodiment of the present invention provides a method for detecting a QoS parameter, which includes.

A network side communication device acquires a QoS parameter obtained by network negotiation during a PDP context activation process.

The network side communication device compares the QoS parameter obtained by the network negotiation with a minimum acceptable QoS (MINQoS) parameter required by terminal equipment (TE), and rejects a current PDP context activation if the QoS parameter obtained by the network negotiation does not satisfy a MINQoS parameter requirement.

Correspondingly, the embodiment of the present invention further provides a network side communication device, which includes: an acquiring unit for acquiring the QoS parameter information obtained by network negotiation during a PDP context activation process; and a processing unit for comparing the QoS parameter with an MINQoS parameter required by a TE, and rejecting a current PDP context activation if the QoS parameter obtained by the network negotiation does not satisfy an MINQoS parameter requirement.

The embodiments of the present invention have the following beneficial effects:

In the embodiments of the present invention, during the PDP context activation process, if the network side communication device determines that the QoS parameter obtained by the network negotiation does not satisfy the MINQoS configured on the MS, the network side communication device rejects to resume the PDP context activation. Therefore, the occupied network and equipment resources are rapidly released during the PDP context activation and deactivation processes, thereby enhancing system work efficiency and network reaction time.

### BRIEF DESCRIPTION OF THE DRAWINGS

FIG. 1 is a structural view illustrating an UMTS system;

FIG. 2 is a flow chart of deactivating a PDP context;

FIG. 3 is a schematic view illustrating a method for detecting a QoS parameter in accordance with an embodiment of the present invention;

FIG. 4 is a schematic view illustrating a method for detecting a QoS parameter in accordance with another embodiment of the present invention;

FIG. 5 is a main structural view illustrating a network side communication device in accordance with an embodiment of the present invention; and

FIG. 6 is a schematic structural view illustrating an SGSN in accordance with the embodiment of the present invention.

### DETAILED DESCRIPTION

In the embodiments of the present invention, a method for detecting a QoS parameter and a network side communication device are provided, in which if the network side communication device determines that the QoS parameter obtained by network negotiation does not satisfy the MINQoS configured on the MS during the PDP context activation process, the network side communication device rejects to resume the PDP context activation, thereby saving the network and equipment resources.

In practical implementations, the network side communication device acquires the QoS parameter obtained by the network negotiation during a PDP context activation process. Then, the network side communication device compares the QoS parameter obtained by network negotiation with the MINQoS parameter required by the TE, and rejects the current PDP context activation if the QoS parameter obtained by network negotiation does not satisfy the MINQoS parameter requirement.

The embodiments of the present invention are described below in detail with reference to the accompanying drawings.

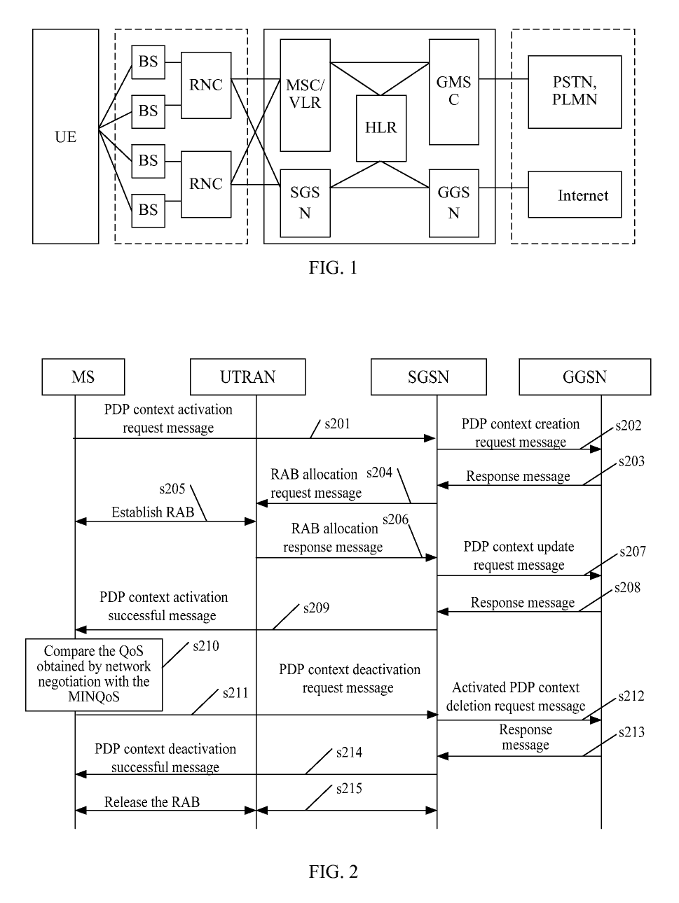

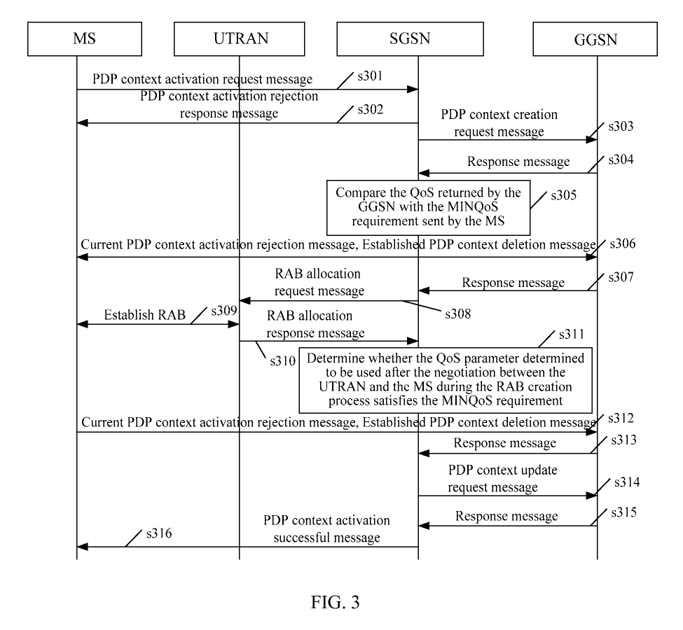

FIG. 3 is a schematic view illustrating a method for detecting a QoS parameter in accordance with an embodiment of the present invention. The method is based on the UMTS system shown in FIG. 1. Referring to FIG. 3, the main flow of the method includes.

Block s301, the MS sends the PDP context activation request message to the SGSN. The PDP context activation request message carries a minimum acceptable QoS parameter required by the MS, i.e., the MINQoS, and carries a requested QoS parameter. Sometimes, the MS also subscribes the QoS parameter in the HLR, and then the SGSN compares the MINQoS with the requested QoS parameter/the subscribed QoS parameter. If it is compared that any one of the requested QoS parameter and the subscribed QoS parameter does not satisfy the MINQoS requirement, Block s302 is executed, if the QoS parameter satisfies the MINQoS requirement, Block s303 is executed.

Particularly, before Block s303 is executed, the method further includes: (1) the SGSN obtains a limited QoS according to the requested QoS and/or the subscribed QoS, the capability of the SGSN and a current load; and (2) the SGSN compares the limited QoS with the MINQoS. If it is found that the limited QoS parameter does not satisfy the MINQoS, Block s302 is executed. If the limited QoS parameter satisfies the MINQoS, Block s303 is executed.

Alternatively, in this step, the SGSN directly obtains a limited QoS according to the requested QoS and/or the subscribed QoS, the capability of the SGSN and a current load. The SGSN compares the limited QoS with the MINQoS, if it is found that the limited QoS parameter does not satisfy the MINQoS, Block s302 is executed, if the limited QoS parameter satisfies the MINQoS, Block s303 is executed.

In order to carry the MINQoS in the PDP context activation request message, an information element (IE) Minimum Acceptable QoS may be added in the PDP context activation message. The type of the IE is Tag Length Value (TLV), and the message structure after the addition is shown in Table 1 below:

TABLE 1

| | Information | | | | |
|---|---|---|---|---|---|
| IEI | Element | Type/Reference | Presence | Format | Length |
| | Protocol | Protocol discriminator 10.2 | M | V | 1/2 |
| | discriminator | | | | |
| | Transaction | Transaction identifier | M | V | 1/2-3/2 |
| | identifier | 10.3.2 | | | |
| | Activate PDP | Message type 10.4 | M | V | 1 |
| | context request | | | | |
| | message identity | | | | |
| | Requested | Network service access | M | V | 1 |
| | NSAPI | point identifier 10.5.6.2 | | | |
| | Requested LLC | LLC service access point | M | V | 1 |
| | SAPI | identifier 10.5.6.9 | | | |
| | Requested QoS | Quality of service 10.5.6.5 | M | LV | 12 |
| | Requested PDP | Packet data protocol | M | LV | 3-19 |
| | address | address 10.5.6.4 | | | |
| 28 | Access point | Access point name | O | TLV | 3-102 |
| | name | | | | |
| 27 | Protocol | Protocol configuration | O | TLV | 3-253 |
| | configuration | options 10.5.6.3 | | | |
| | options | | | | |
| To be | Minimum | Quality of service 10.5.6.5 | O | TLV | 13 |
| determined | acceptable QoS | | | | |

In Table 1, except the Minimum acceptable QoS, the other message contents are the same as those defined in Table 9.5.1/3GPP TS 24.008: “Activate PDP context request message content in 3GPP TS 24.008 V4.14.0 (2004-06).” The descriptions about the added MINQoS is referred to 3GPP TS 24.008 V4.14.0 (2004-06) 10.5.6.5, that is, the content of the MINQoS can be the same as the Requested QoS standard in Table 1, so it is not repeatedly described here.

Block s302: The SGSN sends a PDP context activation rejection response message to the MS, in which the PDP context activation rejection response message may carry rejection reason information “QoS not acceptable”, and the flow ends.

Block s303: The SGSN sends the PDP context creation request message to the GGSN.

Block s304: After establishing the PDP context, the GGSN returns a PDP context creation response message to the SGSN, in which the PDP context creation response message carries the QoS parameter information used by the GGSN for the PDP context.

Block s305: After receiving the PDP context creation response message, the SGSN compares the QoS parameter in the PDP context creation response message with the MINQoS sent by the MS. If the QoS parameter returned by the GGSN does not satisfy the MINQoS requirement, Block s306 is executed, if the QoS parameter returned by the GGSN satisfies the MINQoS requirement, Block s308 is executed.

Block s306: The SGSN rejects the current PDP context activation, sends an established PDP context deletion message to the GGSN and sends a PDP context activation rejection message to the MS, in which the PDP context activation rejection message may carry the rejection reason information “QoS not acceptable.”

Block s307: After deleting the established PDP context, the GGSN returns an established PDP context deletion response message to the SGSN and the flow ends.

Block s308: If the QoS parameter returned by the GGSN satisfies the MINQoS requirement, and after the SGSN determines to establish the RAB, the SGSN sends an RAB allocation request message to the UTRAN.

Block s309: An information interaction is performed between the UTRAN and the MS to establish the RAB. During this process, the UTRAN and the MS continuously negotiate with each other about the QoS used for establishing the RAB.

Block s310: The UTRAN returns an RAB allocation response message to the SGSN. The RAB allocation response message indicates whether the RAB is successfully established between the UTRAN and the MS.

Block s311: The SGSN determines whether the QoS parameter determined to be used after the negotiation between the UTRAN and the MS during a RAB creation process is acceptable for the MINQoS requirement, if the QoS parameter does not satisfy the MINQoS requirement, Block s312 is executed, if the QoS parameter satisfies the MINQoS requirement, Block s314 is executed.

Block s312: If the SGSN determines that the QoS parameter determined to be used after the negotiation between the UTRAN and the MS during the RAB creation process does not satisfy the MINQoS requirement, the SGSN sends an established PDP context deletion message to the GGSN, and sends a current PDP context activation rejection message to the MS.

Block s313: The GGSN sends an established PDP context deletion response message in Block s312 to the SGSN, and the flow ends.

Block s314: If the SGSN determines that the QoS parameter determined to be used after the negotiation between the UTRAN and the MS during the RAB creation process satisfies the MINQoS requirement, the SGSN updates the QoS parameter to be used by the GGSN according to the QoS determined to be used after the negotiation between the UTRAN and the MS.

Block s315: The GGSN sends a response message about updating the QoS parameter used by the GGSN in Block s314 to the SGSN.

Block s316: After acquiring the updating response message from the GGSN, the SGSN sends the PDP context activation successful message to the MS.

In addition, Block s311 may also be realized in the UTRAN, and accordingly, Block s308 to Block s311 have the following alternative flows.

Block a1: The SGSN sends the RAB allocation request message to the UTRAN, in which the RAB allocation request message carries the MINQoS information sent by the MS.

Block a2: The RAB is created between the UTRAN and the MS, and during this process, the UTRAN and the MS negotiate with each other to determine the used QoS parameter.

Block a3: The UTRAN determines whether the QoS parameter determined to be used after the negotiation in Block a2 satisfies the MINQoS acquired in Block a1.

Block a4: If it is determined in Block a3 that the QoS parameter determined to be used after the negotiation between the UTRAN and the MS during the RAB creation process does not satisfy the MINQoS requirement sent by the MS, the UTRAN loops back a notification about triggering the GGSN to delete the established PDP context to the SGSN, and meanwhile, the UTRAN sends the current PDP context activation rejection message to the MS. If it is determined in Block a3 that the QoS parameter determined to be used by the negotiation between the UTRAN and the MS during the RAB creation process satisfies the MINQoS requirement sent by the MS, the UTRAN loops back a notification about triggering to update the QoS parameter used by the GGSN to the SGSN.

In the first embodiment of the method for detecting the QoS parameter, the MINQoS required by the MS, i.e., MINQoS, is reported by the MS, and the network side communication device compares the QoS parameter obtained by network negotiation during the PDP context activation process with the MINQoS to determine whether the network side communication device triggers to reject the current PDP context activation. In the second embodiment of the method for detecting the QoS parameter, the network side communication device acquires the MINQoS in the HLR, and then the network side communication device compares the QoS parameter obtained by network negotiation during the PDP context activation process with the MINQoS, so as to determine whether the network side communication device triggers to reject the current PDP context activation.

In practical applications, merely any one or two steps of Block s301, Block s305 and Block s311 in the embodiment shown in FIG. 3 are used to execute the above comparison operations.

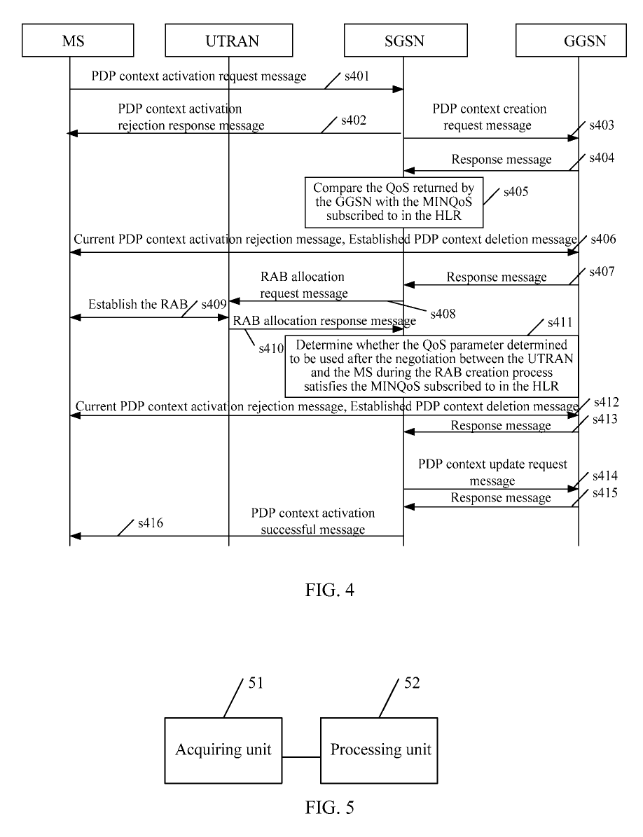

FIG. 4 is a schematic view illustrating a method for detecting a QoS parameter in accordance with another embodiment of the present invention. The method is based on the UMTS system shown in FIG. 1. Referring to FIG. 4, the flow of the method mainly includes the following steps.

Block s401: The MS sends the PDP context activation request message to the SGSN, and the SGSN may acquire the MINQoS stored in the HLR. The PDP context activation request message sent by the MS carries the requested QoS parameter. Sometimes, the MS also subscribes the QoS parameter in the HLR, so the SGSN compares the MINQoS with the requested QoS parameter/the subscribed QoS parameter. If any one of the requested QoS parameter and the subscribed QoS parameter does not satisfy the MINQoS requirement, Block s402 is executed, if one of the requested QoS parameter and the subscribed QoS parameter satisfies the MINQoS requirement, Block s403 is executed.

Particularly, before Block s403, the method further includes: The SGSN obtains the limited QoS according to the requested QoS, and/or the subscribed QoS, the capability of the SGSN and the current load. The SGSN compares the limited QoS with the MINQoS. If the limited QoS parameter does not satisfy the MINQoS, Block S402 is executed, if the limited QoS parameter satisfies the MINQoS, Block s403 is executed.

Alternatively, in this step, the SGSN directly obtains the limited QoS according to the requested QoS and/or the subscribed QoS, the capability of the SGSN and the current load. The SGSN compares the limited QoS with the MINQoS. If the limited QoS parameter does not satisfy the MINQoS, Block S402 is executed, if the limited QoS parameter satisfies the MINQoS, Block s403 is executed.

Block s402: The SGSN sends the PDP context activation rejection response message to the MS, in which the PDP context activation rejection response message may carry the rejection reason information “QoS not acceptable”, and the flow ends.

Block s403: The SGSN sends the PDP context creation request message to the GGSN.

Block s404: After establishing the PDP context, the GGSN returns the PDP context creation response message to the SGSN, in which the PDP context creation response message carries the QoS parameter information used by the GGSN for the PDP context.

Block s405: After receiving the PDP context creation response message, the SGSN compares the QoS parameter in the PDP context creation response message with the MINQoS subscribed to in the HLR. If the QoS parameter returned by the GGSN does not satisfy the MINQoS requirement, Block s406 is executed, if the QoS parameter returned by the GGSN satisfies the MINQoS requirement, Block s408 is executed.

Block s406: The SGSN rejects to resume the current PDP context activation, and sends the established PDP context deletion message to the GGSN, and meanwhile sends the current PDP context activation rejection message to the MS, in which the current PDP context activation rejection message may carry the rejection reason information “QoS not acceptable.”

Block s407: After deleting the established PDP context, the GGSN returns the established PDP context deletion response message to the SGSN, and the flow ends.

Block s408: If the QoS parameter returned by the GGSN satisfies the MINQoS requirement subscribed to in the HLR, and after the SGSN determines to establish the RAB, the SGSN sends the RAB allocation request message to the UTRAN.

Block s409: The information interaction is performed between the UTRAN and the MS. During this process, the UTRAN and the MS continuously negotiate with each other about the QoS parameter used for establishing the RAB.

Block s410: The UTRAN returns the RAB allocation response message to the SGSN, and the RAB allocation response message indicates whether the RAB is successfully established between the UTRAN and the MS.

Block s411: The SGSN determines whether the QoS parameter determined to be used after the negotiation between the UTRAN and the MS during the RAB creation process satisfies the MINQoS requirement subscribed to in the HLR, and if the QoS parameter does not satisfy the MINQoS requirement, Block s412 is executed, if the QoS parameter satisfies the MINQoS requirement, Block s414 is executed.

Block s412: If the SGSN determines that the QoS parameter determined to be used after the negotiation between the UTRAN and the MS during the RAB creation process does not satisfy the MINQoS requirement subscribed to in the HLR, the SGSN sends the established PDP context deletion message to the GGSN, and sends the current PDP context activation rejection message to the MS.

Block s413: The GGSN sends the established PDP context deletion response message in Block s412 to the SGSN.

Block s414: If the SGSN determines that the QoS parameter determined to be used after the negotiation between the UTRAN and the MS during the RAB creation process satisfies the MINQoS requirement, the SGSN updates the QoS parameter to be used by the GGSN according to the QoS determined to be used through the negotiation between the UTRAN and the MS, and the flow ends.

Block s415: The GGSN sends the response message about updating the QoS parameter used by the GGSN in Block s414 to the SGSN.

Block s416: After acquiring the updating response message from GGSN, the SGSN sends the PDP context activation successful message to the MS.

Similarly, Block s411 may also be realized in the UTRAN, and accordingly, Block s408 to Block s411 have similar alternative flows as illustrated in FIG. 3, which are not repeatedly described here.

In practical applications, merely any one or two steps of Block s401, Block s405 and Block s411 in the embodiment shown in FIG. 4 are used to execute the above comparison operation.

The network side communication device of the embodiments of the present invention is described below.

FIG. 5 is a main structural view illustrating a network side communication device in accordance with the embodiment of the present invention. Referring to FIG. 5, the network side communication device mainly includes an acquiring unit 51 and a processing unit 52, and the functions and connection relations between each unit are described as follows.

The acquiring unit 51 is connected to the processing unit 52.

The acquiring unit 51 is adapted to acquire the QoS parameter information obtained by the network negotiation during the PDP context activation process. According to the UMTS system structure of FIG. 1, the QoS parameter information obtained by the network negotiation during the PDP context activation process may be obtained from the network equipments of the CN, for example, the SGSN and the GGSN.

The processing unit 52 is adapted to compare the QoS parameter acquired by the acquiring unit 51 with the MINQoS parameter required by the TE. If the QoS parameter obtained by the network negotiation does not satisfy the MINQoS requirement, the processing unit 52 rejects the current PDP context activation. The MINQoS parameter information required by the TE may be sent by the TE to the network side communication device at an initial stage during the PDP context activation process, and may also be the MINQoS parameter information subscribed to by the TE and acquired by the network side communication device from the HLR.

The network side communication device is illustrated below by taking SGSN as an example, and the TE is the MS.

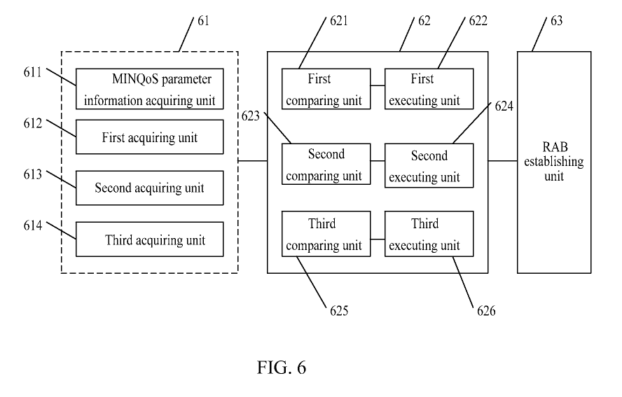

FIG. 6 is a schematic structural view illustrating an SGSN in accordance with the embodiment of the present invention. Referring to FIG. 6, the SGSN includes an acquiring unit 61, a processing unit 62 and an RAB establishing unit 63. The acquiring unit 61 includes a MINQoS parameter information acquiring unit 611, a first acquiring unit 612, a second acquiring unit 613 and a third acquiring unit 614. The processing unit 62 includes a first comparing unit 621, a first executing unit 622, a second comparing unit 623, a second executing unit 624, a third comparing unit 625 and a third executing unit 626. The functions and connection relations between the units are described as follows.

The acquiring unit 61 and the RAB establishing unit 63 are respectively connected to the processing unit 62.

The MINQoS parameter information acquiring unit 611 is adapted to acquire the MINQoS parameter information carried in the PDP context activation request message sent by the MS, or to acquire the MINQoS parameter information of the MS subscribed to in the HLR, i.e., MINQoS. In order to carry the MINQoS in the PDP context activation request message, an IE Minimum Acceptable QoS may be added in the PDP context activation message, and the details are the same as the corresponding descriptions in the first embodiment of the method for detecting the QoS parameter, which are not repeatedly described here.

The first acquiring unit 612 is adapted to acquire the QoS parameter information requested by the TE during the PDP context activation process, i.e., the requested QoS parameter information and/or acquires the QoS parameter information subscribed to by the TE in the HLR, i.e., the subscribed QoS parameter information.

The first comparing unit 621 is adapted to compare the MINQoS acquired by the MINQoS parameter information acquiring unit 611 with the requested QoS parameter/the subscribed QoS parameter acquired by the first acquiring unit 612, i.e., compares whether the requested QoS parameter/the subscribed QoS parameter satisfies the MINQoS requirement.

The first executing unit 622 is adapted to reject the current PDP context activation and send the PDP context activation rejection message to the MS, in which the rejection message includes the rejection reason information “QoS not accepted”, if the comparing result of the first comparing unit 621 is that the requested QoS parameter or the subscribed QoS parameter does not satisfy the MINQoS requirement. If the comparing result of the first comparing unit 621 is that the requested QoS parameter/the subscribed QoS parameter satisfies the MINQoS requirement, the first executing unit 622 resumes the current PDP context activation and saves the MINQoS.

The second acquiring unit 613 is adapted to acquire the QoS parameter information returned after the GGSN establishes the PDP context, in which the QoS parameter information is carried in the PDP context creation response message from the GGSN.

The second comparing unit 623 is adapted to compare the saved MINQoS with the QoS parameter information returned from the GGSN and acquired by the second acquiring unit 613, i.e., to compare whether the QoS parameter information returned from the GGSN satisfies the MINQoS requirement.

The second executing unit 624 is adapted to reject the current PDP context activation, and send the PDP context activation rejection message to the MS, in which the rejection message may carry the rejection reason information “QoS not accepted”, if the comparing result of the second comparing unit 623 is that the QoS parameter returned from the GGSN does not satisfy the MINQoS requirement, The second executing unit 624 is adapted to send the PDP context deletion notify message to the GGSN.

The RAB establishing unit 63 is adapted to initiate to establish the RAB if the comparing result obtained by the second comparing unit 623 is that the QoS parameter returned after the GGSN establishes the PDP context satisfies the MINQoS requirement.

The third acquiring unit 614 is adapted to acquire the QoS parameter information obtained by the RAN equipment through the negotiation during the RAB establishing process after the RAB establishing unit 63 initiates to establish the RAB.

The third comparing unit 625 is adapted to compare the QoS parameter acquired by the third acquiring unit 614 and obtained by the RAN equipment through the negotiation with the MINQoS, i.e., to compare whether the QoS parameter obtained by the RAN equipment through negotiation satisfies the MINQoS requirement.

The third executing unit 626 is adapted to reject the current PDP context activation and notify the GGSN to delete the established PDP context if the comparing result of the third comparing unit 625 is that the QoS parameter obtained by the RAN equipment through the negotiation does not satisfy the MINQoS requirement, i.e., the RAN equipment does not support the MINQoS requirement. The third executing unit 626 updates the QoS parameter used by the GGSN according to the QoS parameter obtained by the RAN equipment through negotiation if the comparing result of the third comparing unit 625 is that the QoS parameter obtained by the RAN equipment through the negotiation satisfies the MINQoS requirement.

In addition, if the above QoS parameters obtained by the network negotiation, for example, the QoS parameter requested/subscribed to by the MS, the QoS parameter obtained by the GGSN when establishing the PDP context and the QoS obtained by the RAN equipment through the negotiation during the RAB establishing process, are all acceptable for the MINQoS requirement, the SGSN sends the PDP context activation successful message to the MS, and it is determined that the PDP context activation is successfully finished.

Furthermore, the acquiring unit 61 in the network side communication device further includes a fourth acquiring unit. The processing unit 62 further includes a fourth comparing unit and a fourth executing unit (not shown in FIG. 6).

The fourth acquiring unit is adapted to acquire the QoS parameter information requested by the TE during the PDP context activation process and/or QoS parameter information subscribed to by the TE in the HLR, and obtains the limited QoS parameter according to the requested QoS parameter and/or the subscribed QoS parameter, capability of the network side communication device and a current load.

The fourth comparing unit is adapted to compare the limited QoS parameter with the MINQoS parameter.

The fourth executing unit rejects to resume the current PDP context activation if the comparing result of the fourth comparing unit is that the limited QoS parameter does not satisfy the MINQoS parameter requirement.

In the network side communication device according to the embodiments of the present invention, for example, the acquiring unit 61 in the SGSN may only include any one or any combination of the first acquiring unit 612, the second acquiring unit 613, the third acquiring unit 614 and the fourth acquiring unit. The processing unit 62 may include any one group or any combination of different groups among the first comparing unit 621 and the first executing unit 622, the second comparing unit 623 and the second executing unit 624, the third comparing unit 625 and the third executing unit 626, and the fourth comparing unit and the fourth executing unit.

During the PDP context activation process, if the SGSN determines that the QoS parameter obtained by the network negotiation does not satisfy the MINQoS configured by the MS, the SGSN triggers to reject the PDP context activation, that is, the rejection of the PDP context activation is realized by the SGSN, so that the occupied network and equipment resources during the PDP context activation are rapidly released in the deactivation process, thereby enhancing the system work efficiency and the network reaction time.

Though illustration and description of the present disclosure have been given with reference to embodiments thereof, it should be appreciated by persons of ordinary skill in the art that various changes in forms and details can be made without deviation from the spirit and scope of this disclosure, which are defined by the appended claims.

What is claimed is:

1. A method for detecting a quality of service (QoS) parameter, comprising:
acquiring, by a network side communication device, a QoS parameter obtained by a network negotiation during a packet data protocol (PDP) context activation process; and
comparing, by the network side communication device, the QoS parameter obtained by the network negotiation with a minimum acceptable QoS (MINQoS) parameter required by a terminal equipment (TE), and rejecting a current PDP context activation if the QoS parameter obtained by the network negotiation does not satisfy an MINQoS parameter requirement.

2. The method according to claim 1, wherein the acquiring, by the network side communication device, the QoS parameter obtained by the network negotiation during the PDP context activation process comprises: acquiring, by the network side communication device, at least one of QoS parameter information requested by the TE during the PDP context activation process, and the QoS parameter information subscribed to by the TE in a home location register (HLR).

3. The method according to claim 1, wherein the acquiring, by the network side communication device, the QoS parameter obtained by the network negotiation during the PDP context activation process comprises:
acquiring, by the network side communication device, at least one of QoS parameter information requested by the TE during the PDP context activation process, and the QoS parameter information subscribed to by the TE in an HLR; and
obtaining, by the network side communication device, a limited QoS parameter according to at least one of the requested QoS parameter, the subscribed QoS parameter, a self-capability, and a current load condition.

4. The method according to claim 1, wherein the acquiring, by the network side communication device, the QoS parameter obtained by the network negotiation during the PDP context activation process comprises:
acquiring, by the network side communication device, QoS parameter information returned after a gateway GPRS support node (GGSN) establishes a PDP context.

5. The method according to claim 4, further comprising:
initiating, by the network side communication device, to establish a radio access bearer (RAB) if the QoS parameter information returned after the GGSN establishes the PDP context satisfies the MINQoS parameter requirement.

6. The method according to claim 1, wherein the acquiring, by the network side communication device, the QoS parameter obtained by the network negotiation during the PDP context activation process comprises:
acquiring, by the network side communication device, the QoS parameter obtained by a radio access network (RAN) equipment negotiation during establishing a RAB.

7. The method according to claim 6, further comprising:
updating, by the network side communication device, the QoS parameter used by a GGSN according to the QoS parameter obtained by the RAN equipment negotiation if it is determined that the QoS parameter obtained by the RAN equipment negotiation satisfies the MINQoS parameter requirement.

8. The method according to claim 1, wherein the MINQoS parameter required by the TE is at least one of:
an obtained MINQoS parameter carried in a PDP context activation message sent by the TE, and
an obtained MINQoS parameter of the TE subscribed to in the HLR.

9. The method according to claim 2, wherein the MINQoS parameter required by the TE is at least one of:
an obtained MINQoS parameter carried in a PDP context activation message sent by the TE, and
an obtained MINQoS parameter of the TE subscribed to in the HLR.

10. The method according to claim 3, wherein the MINQoS parameter required by the TE is at least one of:
an obtained MINQoS parameter carried in a PDP context activation message sent by the TE, and
an obtained MINQoS parameter of the TE subscribed to in the HLR.

11. The method according to claim 4, wherein the MINQoS parameter required by the TE is at least one of:
an obtained MINQoS parameter carried in a PDP context activation message sent by the TE, and
an obtained MINQoS parameter of the TE subscribed to in the HLR.

12. A network side communication device, comprising:
an acquiring unit for acquiring quality of service (QoS) parameter information obtained by network negotiation during a packet data protocol (PDP) context activation process; and
a processing unit for comparing the QoS parameter with a minimum acceptable QoS (MINQoS) parameter required by a terminal equipment (TE), and rejecting a current PDP context activation if the QoS parameter obtained by the network negotiation does not satisfy an MINQoS parameter requirement.

13. The device according to claim 12, wherein the acquiring unit comprises:
a first acquiring unit for acquiring at least one of the QoS parameter information requested by the TE during the PDP context activation process, and the QoS parameter information subscribed to by the TE in a home location register (HLR); and
the processing unit comprises:
a first comparing unit for comparing at least one of the requested QoS parameter and the subscribed QoS parameter acquired by the acquiring unit with the MINQoS parameter; and
a first executing unit for rejecting the current PDP context activation if a comparing result of the first comparing unit is that at least one of the requested QoS parameter and the subscribed QoS parameter does not satisfy the MINQoS parameter requirement.

14. The device according to claim 12, wherein the acquiring unit comprises:
a second acquiring unit for acquiring the QoS parameter information returned after a gateway GPRS support node (GGSN) establishes a PDP context; and
the processing unit comprises:
a second comparing unit for comparing the QoS parameter returned after the GGSN establishes the PDP context with the MINQoS parameter; and
a second executing unit for rejecting the current PDP context activation and notify the GGSN to delete the established PDP context if a comparing result of the second comparing unit is that the QoS parameter returned after the GGSN establishes the PDP context does not satisfy the MINQoS parameter requirement.

15. The device according to claim 12, wherein the acquiring unit comprises:
a third acquiring unit for acquiring the QoS parameter information obtained by a radio access network (RAN) equipment negotiation during establishing a radio access bearer (RAB); and
the processing unit comprises:
a third comparing unit for comparing the QoS parameter obtained by the RAN equipment negotiation with the MINQoS parameter; and
a third executing unit for rejecting the current PDP context activation and notify a GGSN to delete an established PDP context if a comparing result of the third comparing unit is that the QoS parameter obtained by the RAN equipment negotiation does not satisfy the MINQoS parameter requirement.

16. The device according to claim 15, wherein the third executing unit controls to update the QoS parameter used by the GGSN according to the QoS parameter obtained by the RAN equipment negotiation if the comparing result of the third comparing unit is that the QoS parameter obtained by the RAN equipment negotiation satisfies the MINQoS parameter requirement.

17. The device according to claim 12, wherein the acquiring unit comprises:
a fourth acquiring unit for acquiring at least one of the QoS parameter information requested by the TE during the PDP context activation process and the QoS parameter information subscribed to by the TE in an HLR, and obtain a limited QoS parameter according to at least one of the requested QoS parameter, the subscribed QoS parameter, a capability of the network side communication device, and a current load condition; and
the processing unit comprises:
a fourth comparing unit for comparing the limited QoS parameter with the MINQoS parameter; and
a fourth executing unit for rejecting the current PDP context activation if a comparing result of the fourth comparing unit is that the limited QoS parameter does not satisfy the MINQoS parameter requirement.

18. The device according to claim 12, wherein the acquiring unit of the network side communication device comprises:
an MINQoS parameter information acquiring unit for acquiring one of the MINQoS parameter information carried in a PDP context activation request message sent by the TE and the MINQoS parameter information of the TE subscribed to in the HLR.

19. The device according to claim 13, wherein the acquiring unit of the network side communication device comprises:
an MINQoS parameter information acquiring unit for acquiring one of the MINQoS parameter information carried in a PDP context activation request message sent by the TE and the MINQoS parameter information of the TE subscribed to in the HLR.

20. The device according to claim 14, wherein the acquiring unit of the network side communication device comprises:
an MINQoS parameter information acquiring unit for acquiring one of the MINQoS parameter information carried in a PDP context activation request message sent by the TE and the MINQoS parameter information of the TE subscribed to in the HLR.
